(19) United States
(12) Patent Application Publication
(10) Pub. No.: US 2017/0066506 A1
(43) Pub. Date: Mar. 9, 2017

(54) DECK ATTACHMENT DEVICE

(71) Applicant: LOCKHEED MARTIN CORPORATION, BETHESDA, MD (US)

(72) Inventor: Greg W. Klein, Bel Air, MD (US)

(73) Assignee: LOCKHEED MARTIN CORPORATION, BETHESDA, MD (US)

(21) Appl. No.: 14/845,424

(22) Filed: Sep. 4, 2015

(51) Int. Cl. B63B 21/04; F16B 21/02

(52) U.S. Cl. CPC B63B 21/04; F16B 21/02

(57) ABSTRACT

A deck attachment device for affixing hardware to a naval vessel deck by engaging an existing deck tie-down fixture installed in the deck. The device includes claws extending from a lower surface of a base. The claws of the deck attachment device are configured and positioned to engage the spokes of a crossbar portion of the deck tie-down fixture when the deck attachment device is placed on the deck tie-down fixture with its claws extending into quadrants defined by the spokes of the deck tie-down fixture crossbar, and then rotated to an engaged position relative to the deck tie-down fixture.

### CROSS-REFERENCES TO RELATED APPLICATIONS

Not Applicable

### STATEMENT REGARDING FEDERALLY SPONSORED RESEARCH OR DEVELOPMENT

Not Applicable

### BACKGROUND

Field

This application relates generally to the use of deck attachment device for affixing hardware to a naval vessel deck.

Description of Related Art Including Information Disclosed Under 37 CFR 1.97 and 1.98

Deck tie-down fixtures are known for use in attaching lines or cables to naval vessel decks. Such fixtures include a downwardly-convex circular base and a cylindrical sidewall that extends integrally upward from around a circumferential outer edge of the base. Also included in such fixtures is a generally X-shaped crossbar that comprises spokes extending integrally and radially inward from spaced locations around an inner circumferential surface of the sidewall. Such a fixture will generally be countersunk into a naval vessel deck such that an upper rim surface of the fixture and upper surface of the crossbar lie flush with an upper surface of the deck.

### SUMMARY

A deck attachment device is provided for affixing hardware to a naval vessel deck. The device includes a base, and claws extending from a lower surface of the base. The claws are configured and positioned to engage spokes of a deck tie-down fixture crossbar when the device is rotated to an engaged position relative to the fixture.

Also, a method is provided for affixing hardware to a naval vessel deck. The method includes the steps of rotating a claw of a hardware mounting device into engagement with a deck tie-down fixture crossbar, and attaching hardware to a mechanical interface structure of the device.

### DRAWING DESCRIPTIONS

These and other features and advantages will become apparent to those skilled in the art in connection with the following detailed description and drawings of one or more embodiments of the invention, in which:

FIG. 1 is an isometric view of a deck attachment device disengaged from a prior art deck tie-down fixture countersunk in a deck;

FIG. 2 is a cross-sectional bottom view of the deck attachment device and deck tie-down fixture of FIG. 1 taken along line 2-2 of FIG. 1, but with claws of the deck attachment device inserted into respective quadrants defined by spokes of a crossbar of the deck tie-down fixture;

FIG. 3 is a cross-sectional bottom view of the deck attachment device and deck tie-down fixture of FIG. 1 taken along line 2-2 of FIG. 1, with claws of the deck attachment device rotated into engagement with the spokes of the deck tie-down fixture crossbar;

FIG. 4 is a cross-sectional front view of the deck attachment device and deck tie-down fixture of FIG. 1 taken along line 4-4 of FIG. 3, with claws of the deck attachment device rotated into engagement with the spokes of the deck tie-down fixture crossbar;

FIG. 5 is an isometric view of a deck attachment device disengaged from a prior art deck tie-down fixture, and bolts and bolt holes of a first anti-counter-rotation feature;

FIG. 6 is an isometric bottom view of the deck attachment device and deck tie-down fixture of FIG. 5 showing claws of the deck attachment device rotated into engagement with the spokes of the deck tie-down fixture crossbar and with the bolts of the first anti-counter-rotation feature threadedly engaged with the holes of the first anti-counter-rotation feature and extending into respective positions block counter-rotation of the claws;

FIG. 7 is a cross-sectional isometric top view of a deck attachment device and deck tie-down fixture with claws of the deck attachment device shown rotated into engagement with crossbar spokes of the deck tie-down fixture and with tensioning bolts threadedly engaged in tensioning bolt holes and showing a lower end of one of the tensioning bolts having been threadedly advanced into contact with one of the crossbar spokes;

FIG. 8 is an isometric bottom view of a deck attachment device showing four capture pins of a fourth anti-counter-rotation feature received in respective holes formed through a base of the device in respective positions where the capture pins will close open ends of claws of the device;

FIG. 9 is an isometric top view of the deck attachment device and anti-counter-rotation feature of FIG. 8;

FIG. 10 is a cross-sectional isometric top view of the deck attachment device and deck tie-down fixture of FIG. 9 with claws of the deck attachment device shown rotated into engagement with crossbar spokes of a deck tie-down fixture and with capture pins of the fourth anti-counter-rotation feature shown threadedly engaged in holes of the fourth anti-counter-rotation feature and showing one of the capture pins received in a hole in one of the claws of the deck attachment device, capturing one of the spokes of a crossbar portion of the deck tie-down fixture;

FIG. 11 is an isometric top view of a deck attachment device comprising a mechanical interface structure including a hoist ring;

FIG. 12 is an isometric bottom view of a deck attachment device comprising a mechanical interface structure including a pillow block;

FIG. 13 is an isometric top view of a rod received in two pillow blocks carried by two deck attachment devices, respectively, each deck attachment device being engaged with a deck tie-down fixture recessed in a deck;

FIG. 14 is an isometric top view of a deck attachment device comprising a mechanical interface structure including a bolt hole; and

FIG. 15 is an isometric top view of a structure fixed to a deck by a bolt extending through a portion of the structure and into a bolt hole in the deck attachment device of FIG. 14.

### DETAILED DESCRIPTION

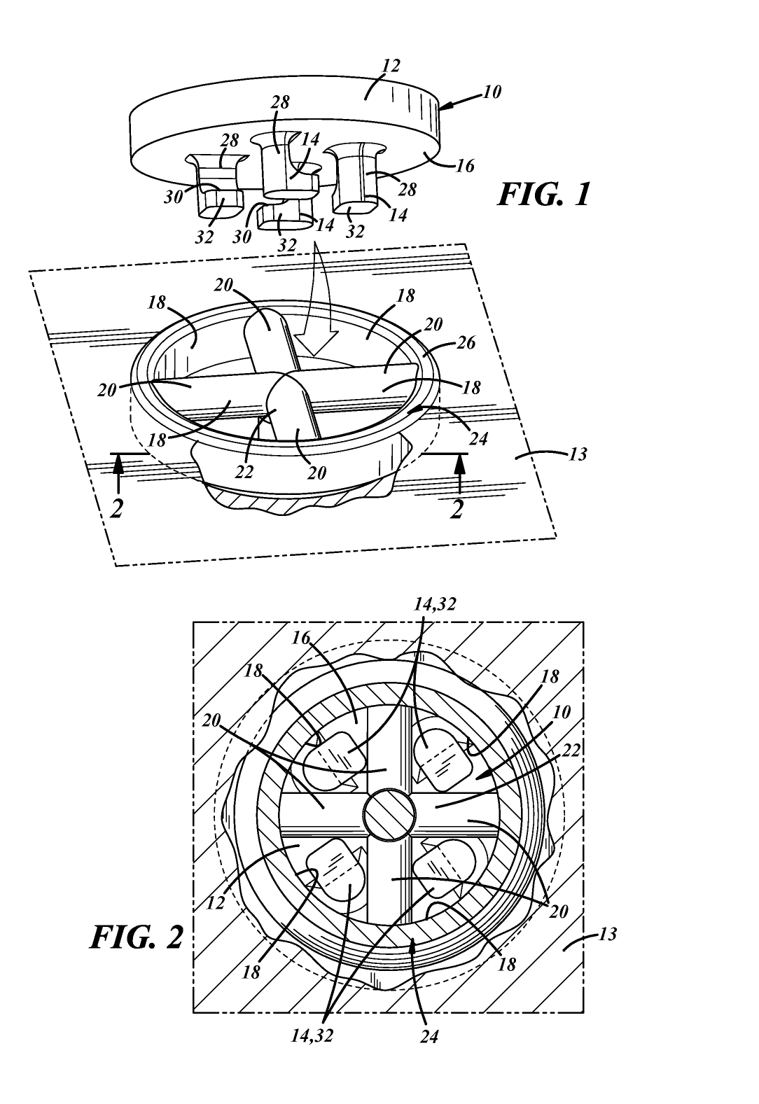

A deck attachment device for affixing hardware to a naval vessel deck is generally indicated at 10 in FIGS. 1-15. The device 10 may include a base plate 12 and may also include claws 14 extending from a lower surface 16 of the base plate 12. The claws 14 may be configured and positioned to be inserted downward into quadrants 18 defined between radially-oriented spokes 20 of a crossbar 22 of a deck tie-down fixture 24 when the base plate 12 is lowered into a position resting on an upper rim 26 of the fixture 24, and to then engage the spokes 20 of the deck tie-down fixture crossbar 22 when the deck attachment device 10 is rotated to an engaged position relative to the tie-down fixture 24 as shown in FIG. 3. In other words, and as best shown in FIGS. 13 and 15, the deck attachment device 10 affixes hardware 11 to a deck 13 by engaging a deck tie-down fixture 24 installed in the deck 13. The claws 14 of the deck attachment device 10 may be configured to preclude removal of the attachment device 10 from the tie-down fixture 24 without first disengaging the claws 14 from the spokes 20 of the tie-down fixture crossbar 22 by counter-rotating the attachment device 10 out of the engaged position.

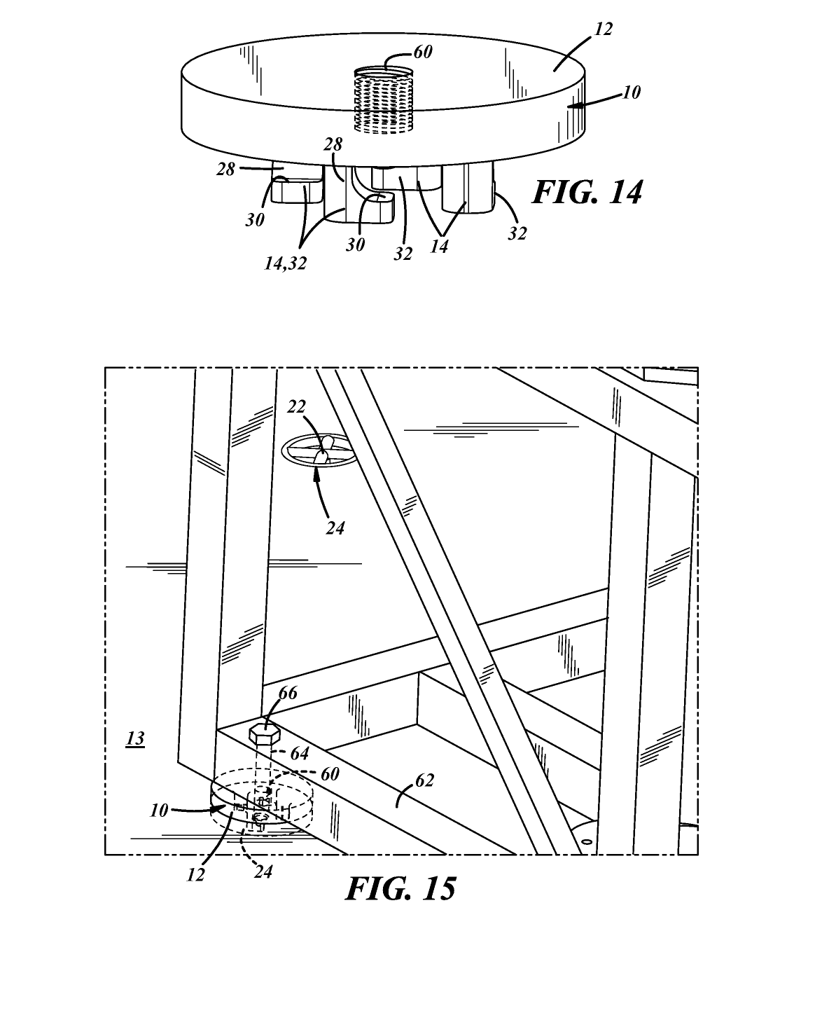

As best shown in FIGS. 1 and 14, the claws 14 may extend integrally downward from the lower surface 16 of the base plate 12 and may be integrally formed with the base plate 12 as a single unitary piece. Each claw 14 may include a generally axially-extending stem portion 28 and a generally upward-facing engagement detent surface 30 disposed on a hook portion 32 of the claw, which, as best shown in FIGS. 1, 7, 8, 10, and 14, extends generally horizontally from the stem portion 28 such that the engagement detent surfaces 30 are in respective positions to firmly engage respective undersides of the spokes 20 of a deck tie-down fixture crossbar 22 when the device 10 is in the engaged position. In other words, the stem portions 28 of the claws 14 are long enough to position the engagement detent surfaces 30 low enough to hook under the crossbar 22 spokes 20 upon rotation of the device 10 to the engaged position.

The engagement detent surfaces 30 may extend tangentially from their respective claw stem portions 28 in a clockwise direction, as shown in the drawings, or all the of the engagement detent surfaces 30 may instead extend tangentially from their respective claw stem portions 28 in a counter-clockwise direction, depending on an intended or desired direction of twisting engagement. With all engagement detent surfaces 30 extending tangentially in the same direction, all of the engagement detent surfaces 30 will move into engagement with the underside of one of the spokes 20 of a deck tie-down fixture crossbar 22 when the device 10 is rotated to the engaged position.

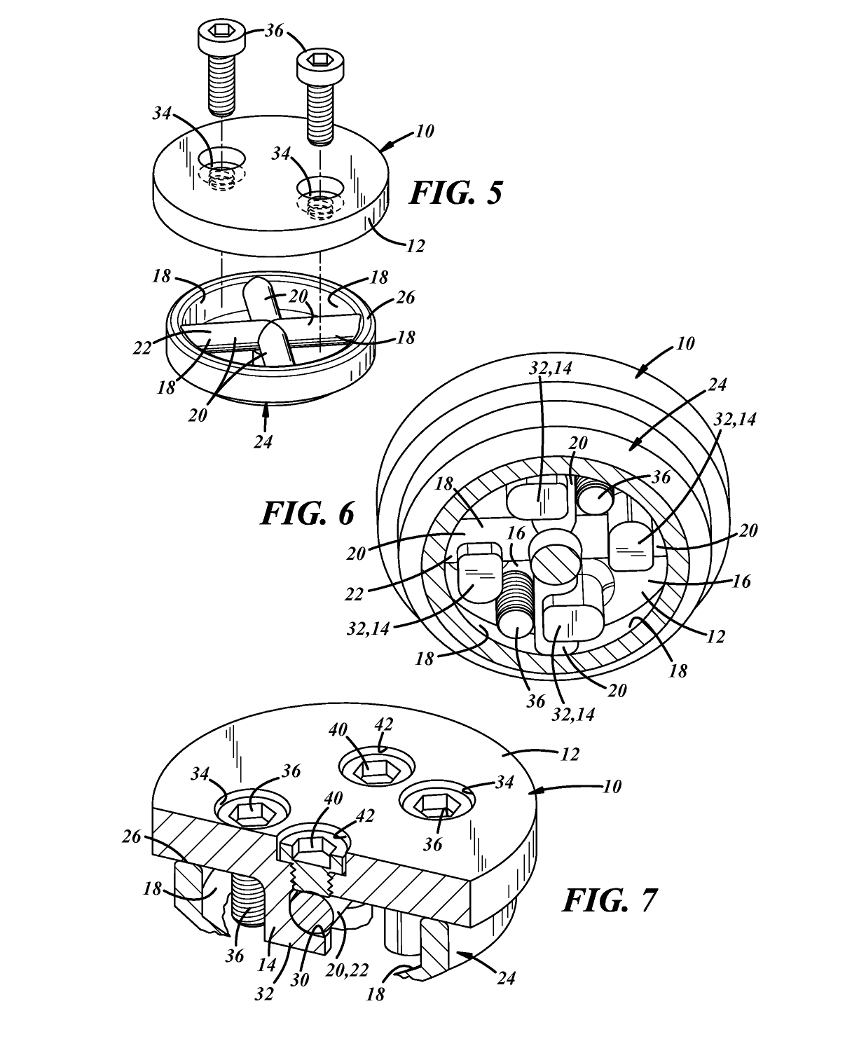

As shown in FIGS. 5-10, the deck attachment device 10 may include an anti-counter-rotation feature that resists rotation of the device 10 out of the engaged position relative to a deck tie-down fixture 24, and consequent disengagement of the claws 14 from the tie-down fixture 24. As shown in FIGS. 5-7, the anti-counter-rotation feature may include threaded bolt holes 34 formed through the base plate 12 in respective positions where blocking bolts 36 installed in the bolt holes 34 will protrude downward from the lower plate surface 16, as shown in FIG. 6, into respective positions blocking counter-rotation of the deck attachment device 10 out of its engaged position.

As shown in FIG. 7 tensioning bolts 40 may also or alternatively be threadedly engaged in respective tensioning bolt holes 42 formed through the base plate 12 in respective positions where they will be located over and axially aligned with respective spokes 20 of a tie-down fixture crossbar 22 when the device 10 has been rotated into its engaged position on a deck tie-down fixture 24. This allows the tensioning bolts 40 to be advanced until they engage the spokes 20 of the tie-down fixture crossbar 22, removing slop and minimizing vibration between the device 10 and the tie-down fixture 24, and secondarily providing mechanical resistance against relative rotation.

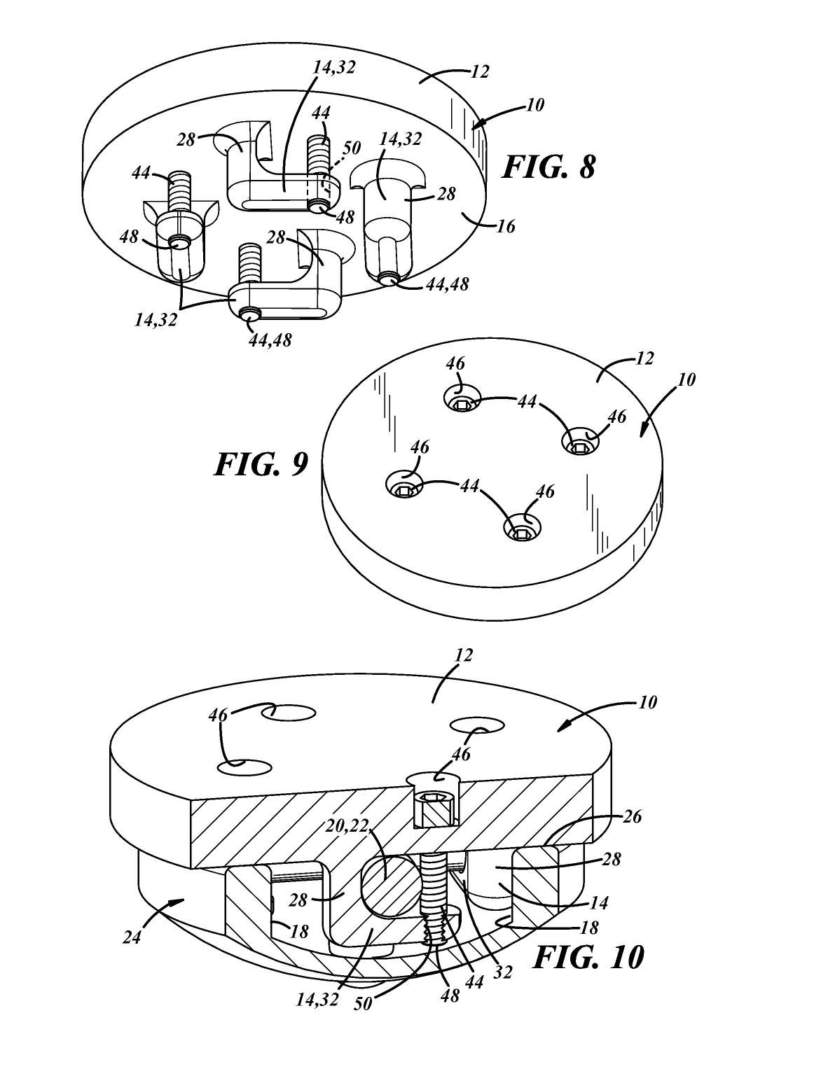

As shown in FIGS. 8-10, the anti-counter-rotation feature might instead, or additionally include capture pins 44 received in respective capture pin holes 46 formed through the base plate 12 in respective positions where the capture pins 44 will extend through the lower plate surface 16 and across respective open ends of the claws 14. In these positions, the capture pins 44 preclude counter-rotation by trapping the spokes 20 of a deck tie-down fixture crossbar 22. Lower tips 48 of the capture pins 44 may be received in respective recesses or holes 50 formed adjacent respective distal ends of the claws 14 to further secure the capture pins 44 against any counter-rotational forces exerted by the spokes 20. As shown in FIGS. 8-10 the distal ends of the claws 14 may be extended to accommodate the holes 50.

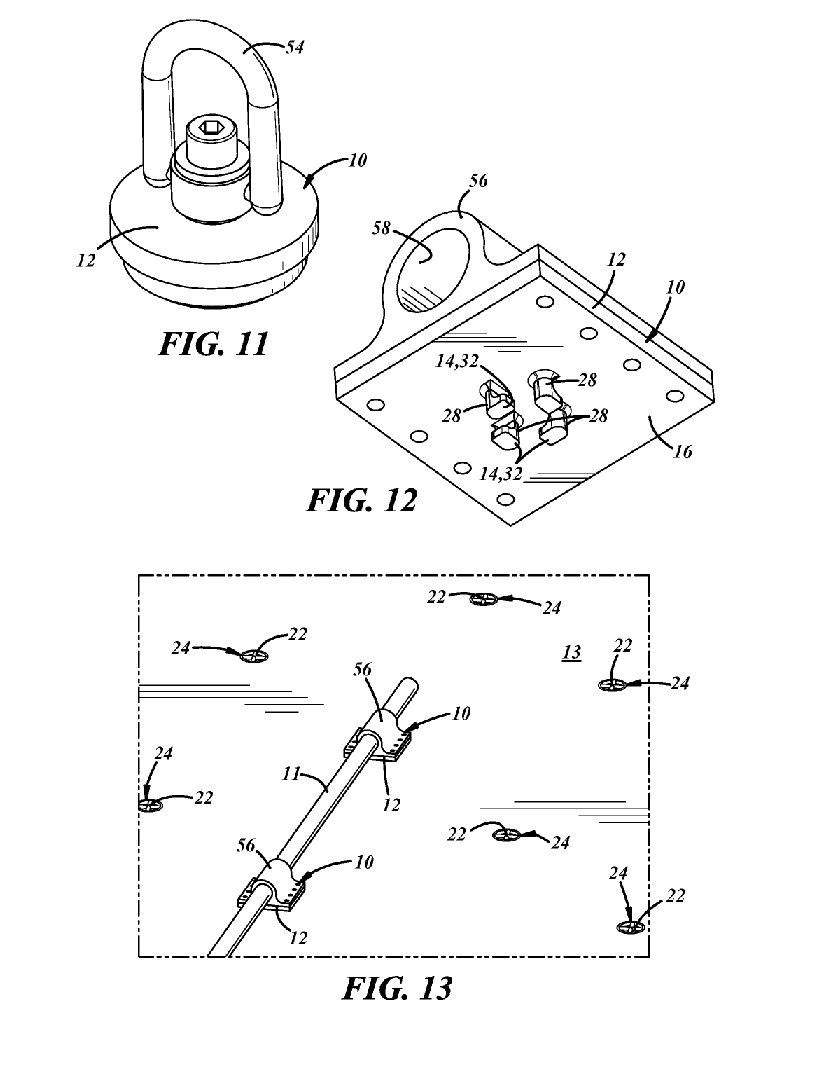

As shown in FIGS. 11-15, a mechanical interface structure may be carried by the base plate 12. The mechanical interface structure may be configured to attach hardware 54 to the device 10 and, thereby, to a deck tie-down fixture 24 installed in a deck 13, when the device 10 is in the engaged with the deck tie-down fixture 24.

As shown in FIG. 11, the mechanical interface structure may include a hoist ring 54. The hoist ring may be fixedly coupled to the base plate 12 of the attachment device 10 or, as shown in FIG. 11, may be supported for pivotal motion on the base plate 12.

As shown in FIGS. 12 and 13, the mechanical interface structure may include a pillow block 56 having a receptacle 58 shaped to receive a portion or component of a hardware structure 11 to be affixed to a deck 13. As shown in FIG. 13, two or more devices 10 may be mounted on respective deck tie-down fixtures 24 in positions to receive different portions or components of a hardware 11 structure to be mounted on the deck 13. When two or more devices 10 are carrying a single structural element 11 as shown in FIG. 13, the structural element 11 provides an anti-counter-rotation effect by securing each of the devices 10 against rotation out of their respective engaged positions on the deck tie-down fixtures 24.

As shown in FIG. 14, the mechanical interface structure may include a threaded bolt hole 60 formed in or through the base plate 12 of an attachment device 10. As shown in FIG. 15, such an attachment device may be engaged with a deck tie-down fixture 24 mounted in a deck 13, and then a portion or component of a hardware structure 62 placed on the attachment device 10. A through-hole 64 formed through the portion or component of the hardware structure 62 may be axially aligned with the threaded bolt hole 60 in the base plate 12 of the attachment device 10, and a threaded fastener 66 passed through the through-hole 64 into threaded engagement with the threaded bolt hole 60.

The mechanical interface structure may alternatively or additionally include one or more brackets, clamps, or any other suitable structure or combination of structures capable of affixing hardware to the attachment device 10, and may additionally or alternatively be configured to attach one or more components of a UAV capture system.

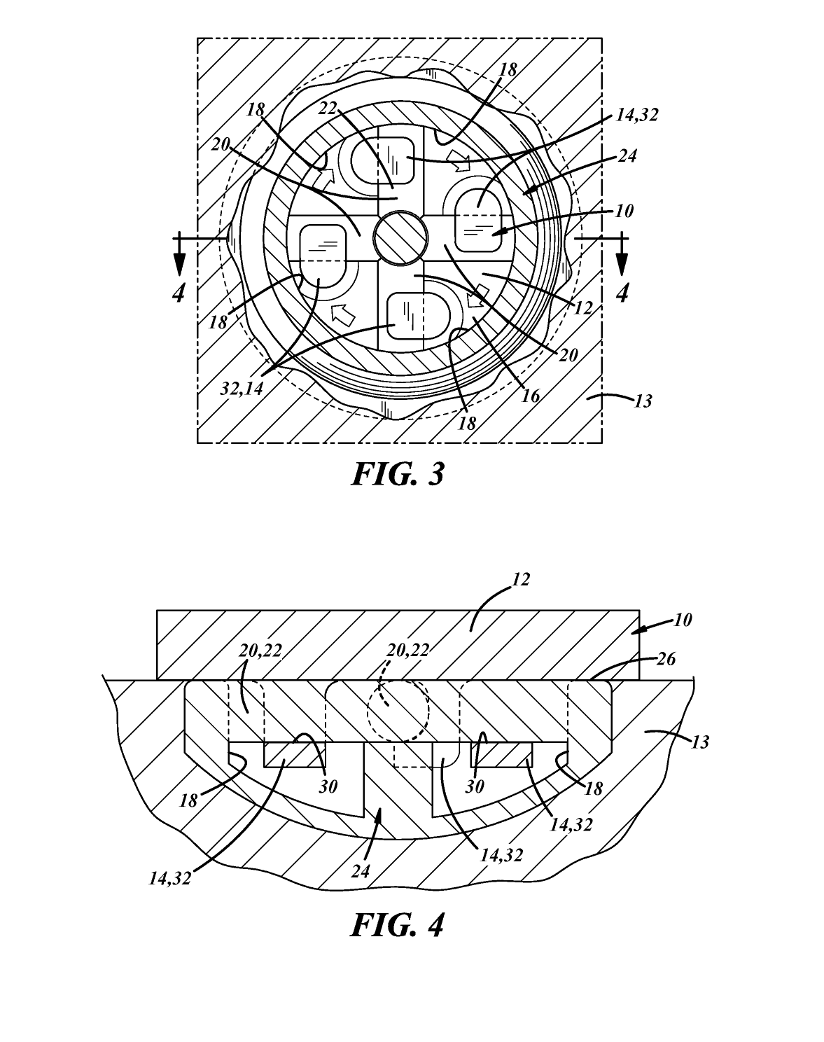

In practice, hardware, such as components of a UAV capture system, can be affixed to a deck 13 by inserting the claws 14 of the hardware mounting device 10 into respective quadrants 18 defined by spokes 20 of a deck tie-down fixture 24 crossbar 22 with the deck tie-down fixture 24 being mounted in the deck as shown in FIGS. 1 and 2. The claws 14 of the hardware mounting device 10 may then be rotated into engagement with respective spokes 20 of the crossbar 22 of the deck tie down fixture 24 as shown in FIGS. 3 and 4. Disengagement of the device 10 from the tie-down fixture 24 may then be precluded by engaging an anti-rotation feature of the device 10 as shown in FIGS. 5-10. A hardware structure 11 is then affixed to a mechanical interface structure of the device 10 as shown in FIG. 15. As is also shown in FIG. 15, the hardware structure 11 may be fixedly coupled to the mechanical interface structure of the device 10 to preclude motion of the hardware structure 11 relative to the deck 13.

A hardware mounting device 10 constructed as indicated above, provides a simple way of attaching and securing structures to tie-down fixtures typically found mounted in the decks of naval vessels, without having to string-out chains or lines, which create tripping hazards, require a significantly larger footprint, and are limited to applying and resisting force in tension.

This description, rather than describing limitations of an invention, only illustrates embodiments of the invention recited in the claims. The language of this description is therefore exclusively descriptive and is non-limiting.

Obviously, it's possible to modify this invention from what the description teaches. Within the scope of the claims, one may practice the invention other than as described above.

What is claimed is:

1. A deck attachment device for affixing hardware to a naval vessel deck, the device comprising:
a base;
claws extending from a lower surface of the base, the claws being configured and positioned to engage spokes of a deck tie-down fixture crossbar when the device is rotated to an engaged position relative to the fixture.

2. A deck attachment device as defined in claim 1 in which the claws extend integrally from the base.

3. A deck attachment device as defined in claim 1 in which the claws are integrally formed with the base as a single unitary piece.

4. A deck attachment device as defined in claim 1 in which each claw includes:
a stem portion; and
an engagement detent surface disposed on a hook portion of the claw that extends generally horizontally from the stem portion such that the engagement detent surface is in a position to engage an underside of one of the spokes of a deck tie-down fixture crossbar when the device is in the engaged position.

5. A deck attachment device as defined in claim 4 in which all of the engagement detent surfaces extend tangentially in a clockwise direction or all the engagement surfaces extend tangentially in a counter-clockwise direction.

6. A deck attachment device as defined in claim 1 and further comprising an anti-counter-rotation feature configured to resist rotation of the device out of the engaged position.

7. A deck attachment device as defined in claim 6 in which the anti-counter-rotation feature includes a threaded bolt hole formed through the base in a position where a bolt installed in the bolt hole will protrude downward from a lower plate surface into a position blocking counter-rotation of the device out of its engaged position.

8. A deck attachment device as defined in claim 6 in which the anti-counter-rotation feature includes a tensioning bolt threadedly engaged in a hole formed through the base in a position where it will be located over and axially aligned with a tie-down fixture crossbar when the device has been rotated into its engaged position on the fixture.

9. A deck attachment device as defined in claim 6 in which the anti-counter-rotation feature includes a capture pin received in a hole formed through the base in a position where it will close an open end of the claw trapping tie-down fixture crossbar spokes.

10. A deck attachment device as defined in claim 9 in which the capture pin includes a tip that is received in a hole formed in the claw.

11. A deck attachment device as defined in claim 1 further comprising a mechanical interface structure carried by the base and configured for hardware attachment to the device.

12. A deck attachment device as defined in claim 11 in which the mechanical interface structure includes one or more structures selected from the group of structures consisting of a bolt hole, a bracket, a clamp, a pillow block, and a hoist ring.

13. A deck attachment device as defined in claim 11 in which the mechanical interface structure is configured to attach one or more components of a UAV capture system to a deck of a naval vessel.

14. A method for affixing hardware to a naval vessel deck, the method comprising the steps of:
rotating a claw of a hardware mounting device into engagement with a deck tie-down fixture crossbar; and
attaching hardware to a mechanical interface structure of the device.

15. The method of claim 14 including the additional step of inserting the claw of the hardware mounting device into a quadrant defined by spokes of the deck tie-down fixture crossbar before the step of rotating the claw into engagement with the deck tie-down fixture crossbar.

16. The method of claim 14 in which the step of attaching hardware to a mechanical interface structure of the device includes fixedly coupling the hardware to the mechanical interface structure of the device.
